(19) United States
(12) Patent Application Publication
(10) Pub. No.: US 2019/0036994 A1
(43) Pub. Date: Jan. 31, 2019

(54) Online Platform For Streaming Electronic Publications To Subscriber Devices

(71) Applicants: Paul Ngaele NGALLE, Kennesaw, GA (US); Michael David RUSSELL, Hiram, GA (US); Muhatashim ZARIF, Kennesaw, GA (US); Kennesaw State University Research and Service Foundation, Inc., Kennesaw, GA (US)

(72) Inventors: Paul Ngaele NGALLE, Kennesaw, GA (US); Michael David RUSSELL, Hiram, GA (US); Muhatashim ZARIF, Kennesaw, GA (US)

(73) Assignee: Kennesaw State University Research and Service Foundation, Inc., Kennesaw, GA (US)

(21) Appl. No.: 16/070,158

(22) PCT Filed: Jan. 13, 2017
(86) PCT No.: PCT/US17/13276

§ 371 Date: Jul. 13, 2018

Related U.S. Application Data
(60) Provisional application No. 62/279,299, filed on Jan. 15, 2016.

(51) Int. Cl. H04L 29/06; H04L 29/08; G06F 3/0484; G06F 3/0483

(52) U.S. Cl. CPC H04L 65/60; G06F 3/0483; G06F 3/04842; H04L 67/1097

(57) ABSTRACT

An online streaming platform that allows subscribers to access a fixed number of e-books within a library for a fee paid on a periodic basis. The online streaming platform includes a plurality of cloud servers storing subscriber information and a plurality of storage servers in communication with the plurality of cloud servers. At least one of the storage servers stores a e-textbook library containing the contents of a plurality of e-books. The e-books are not saved or downloadable to a client device of a subscriber.

This application claims priority to U.S. Ser. No. 62/279,299 filed Jan. 15, 2016, which is expressly incorporated by reference in its entirety.

### BACKGROUND

Traditional textbooks used in a college or a university setting are typically expensive. As a result, students attempt to save money by purchasing digital editions of their textbooks, which are referred to as e-textbooks, online. Several online merchants are available that enable students to purchase traditional textbooks, e-books, and e-textbooks online. Some of these online merchants may permit students to copy and print specific e-textbooks, up to a specific limit, when purchasing their e-textbooks. Another specific online merchant also sells e-books and e-textbooks, online magazines, and online newspapers through their app.

All these online merchants require an individual to purchase an e-book individually. This means that a student must purchase each and every e-textbook he or she needs separately from one another. The costs associated with purchasing multiple e-textbooks may become cost-prohibitive for a student, especially if he or she is taking a full course load or additional classes.

Other drawbacks when purchasing e-books online are that e-books sold by some online merchants currently do not offer a virtual or animated two-page flip feature, which provides a realistic page-flipping feature that mimics both the look and sound of turning pages of a traditional book. Further, no online merchants allow users to mark or annotate the e-book online. As a result some students may become frustrated when viewing their study materials online because they cannot make notes or highlight pages within their e-textbook as they would using a traditional textbook while studying.

A solution that provides access to e-books in a more cost-effective manner is thus needed.

### BRIEF DESCRIPTION OF THE DRAWINGS

FIG. 1 diagrams architecture of an exemplary online streaming platform including an e-textbook library.

FIG. 2 is a flow diagram illustrating two approaches how a subscriber may gain access to the e-textbook library shown in FIG. 1.

FIG. 3 is exemplary webpage illustrating a sign-in page that a subscriber may use to log into his or her account associated with the online streaming platform.

FIG. 4 is exemplary webpage illustrating a homepage of the online streaming platform.

FIG. 5 shows three exemplary pages of an e-textbook based on an animated two-page flip feature.

FIGS. 6A-6B are exemplary screens demonstrating a copyright protection feature of the online streaming platform.

FIG. 7 is an exemplary view of the pages of the e-textbook shown in FIG. 5, where two blocks, block 1 and block 2 are superimposed.

FIG. 8 is a process flow diagram illustrating a method for dynamically rendering pages based on an ePub file

FIG. 9 is a block diagram of an exemplary computer system.

### SUMMARY

In one embodiment, an online streaming platform is disclosed. The online streaming platform includes a plurality of cloud servers storing subscriber information and a plurality of storage servers in communication with the plurality of cloud servers. At least one of the storage servers stores a e-textbook library containing the contents of a plurality of e-books. The online streaming platform allows for subscribers to access a fixed number of e-books within the e-textbook library for a fee that is paid on a periodic basis.

In another embodiment, a system for preventing a subscriber from reproducing text displayed upon a screen of a client device is disclosed. The system comprises at least one processor and a memory coupled to the processors. The memory stores data comprising program code that, when executed by the one or more processors, causes the system to monitor an area of the screen of the client device that is located outside of a window's margins. The window is a separate viewing area on the screen of the client device. The window contains a plurality of characters oriented along an axis. The system is further caused to determine if a subscriber has selected text on the area of the screen located outside of the window's margins using a selector. In response to determining that the subscriber has selected text outside of the window's margin, the system is caused to invert the plurality of characters oriented along the axis.

In another embodiment, a system for preventing a subscriber from reproducing text displayed upon a screen of a client device is disclosed. The system comprises at least one processor and a memory coupled to the processors. The memory stores data comprising program code that, when executed by the one or more processors, causes the system to monitor an area of the screen of the client device that is located outside of a window's margins. The window is a separate viewing area on the screen of the client device. The window contains a plurality of characters. The system is further caused to determine if a subscriber has selected text on the area of the screen located outside of the window's margins using a selector. In response to determining that the subscriber has selected text outside of the window's margin, the system is caused to remove the characters from the window so that the window appears blank.

In another embodiment, a system for preventing a subscriber from photographing a display of a client device by another electronic device is disclosed. The system includes at least one processor and a memory coupled to the processors. The memory stores data comprising program code that, when executed by the one or more processors, causes the system to send data to the client device to refresh the display at a predetermined rate, where the predetermined rate is higher than about 60 Hz.

The inventive systems and methods effect improvement in online systems for electronic publications by providing an online platform where publishers stream the electronic publications, such as e-books, to users for a subscription fee. The e-books are not saved or downloaded to the subscriber's electronic device. Instead, the e-books are stored using a cloud-based approach, and the subscriber's device acts as a thin client that has continual access to the cloud. The online platform also includes a copyright protection feature that prevents the subscriber from printing, taking screen shots, copying and pasting text, or taking photographs of the pages of an e-textbook using a camera. The screen may be, e.g., a light emitting diode (LED) display or a liquid crystal display (LCD). Where exemplary embodiments reference purchasing e-textbooks for university use, it will be appreciated that the invention is not limited to an academic environment or to e-textbooks, and also encompasses e-books, online magazines, periodicals, newspapers, etc.

The online streaming platform allows subscribers to access a fixed number of e-textbooks within an e-textbook library for a fee paid on a periodic basis. The library stores numerous e-books that may be presented based on title, author, publishing company, or International Standard Book Number (ISBN). The fixed number of books may depend on the specific fee paid by a subscriber, where a higher fee enables a user to access more e-textbooks. For example, in one approach the subscriber may be able to purchase access to either four, six, or ten e-textbooks as part of the subscription to the online streaming platform. However, it should be appreciated that a subscriber may choose to access a different number of e-textbooks.

The online streaming platform allows a user to access to multiple e-textbooks, without needing to actually purchase each e-book individually. Thus, subscribers may save money by only accessing the e-textbooks when needed, instead of purchasing multiple e-textbooks or traditional textbooks. Where exemplary embodiments may reference a periodic amount of time expressed on a monthly basis, it should be appreciated that the invention is not so limited and may be based on other periodic amounts of time such as, e.g., hourly, weekly, quarterly, or a semester basis.

In one approach, the subscription that allows access to the e-textbook library begins on the day the subscriber submits payment for the subscription service. In another approach, the subscription may allow for access to the e-textbook library on the first day of registration for an academic year granted that the subscriber has made payment. In one embodiment, the subscription may be reset on a periodic basis. For example, the subscription service may be reset every month or on a semester basis. Once the subscription is reset, a different set of e-textbooks may be selected for user access. Thus, a student is able to select different e-textbooks based on the classes that are taken per semester.

In one approach, a subscriber may purchase limited access to the library. The limited access may allow the subscriber to only view selected portions of an e-book. For example, the subscriber may only be able to view selected chapters from the e-book. Alternatively or in addition to the ability to view only a portion of the e-book, the limited access may also allow the subscriber to only access the e-book for a certain amount of time such as, e.g., a few hours or a day. For example, the subscriber may be only able to view the book for six hours.

The online streaming platform may also display the e-textbooks using an animated two-page flip feature that mimics both the look and sound of turning pages of a traditional paper-bound book. The animated two-page flip feature may enable a user to view more than one page at a time on a Graphical User Interface (GUI). The online streaming platform may also allow subscribers to modify the appearance or annotate the pages of the e-textbook. Specifically, a subscriber may highlight text or pictures (in different colors), mark or tab pages, or make text notes on the pages of the e-textbook. The changes to the e-book will be saved so if the subscriber logs off the online streaming platform, the annotations made to the e-textbook will still be available once the subscriber logs back into the online streaming platform.

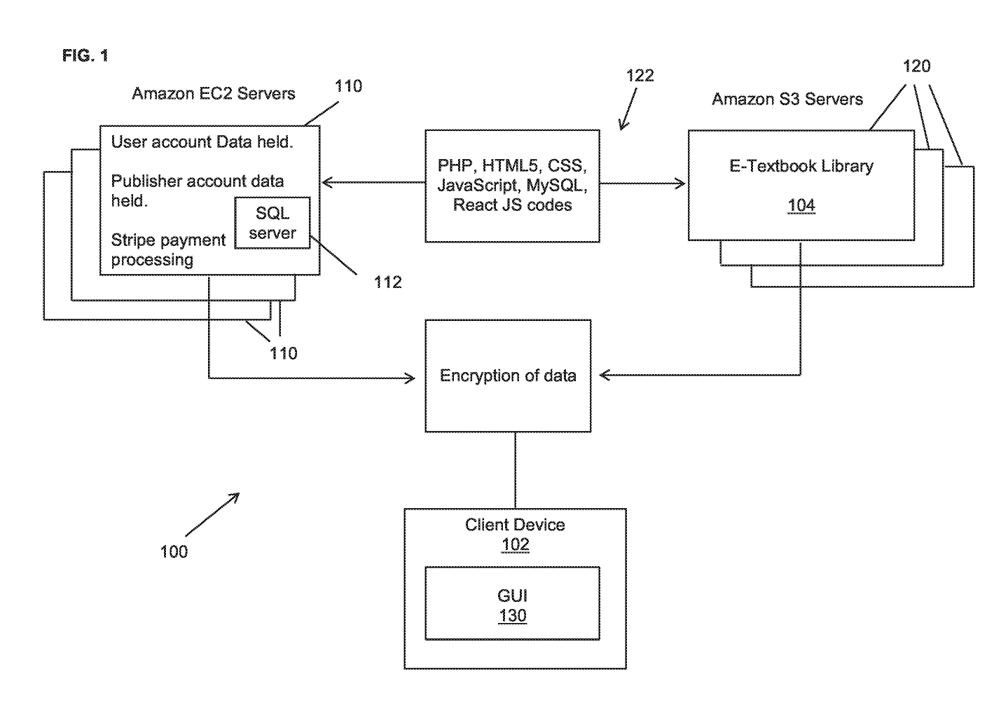

FIG. 1 shows an exemplary online streaming platform 100 for streaming electronic publications stored in an online e-textbook library 104 to one or more client devices 102. The client devices 102 may be, but are not limited to, a smartphone, laptop computer, e-reader, or tablet. In the embodiment shown in FIG. 1, the online streaming platform 100 is executed based on cloud computing services, such as cloud computing services provided by Amazon, and in particular Amazon's Elastic Compute Cloud (Amazon EC2). However, it is to be appreciated that FIG. 1 is merely exemplary, and the online streaming platform 100 is not limited to the illustrated embodiment. For example, in another embodiment the online streaming platform 100 may be executed using Amazon's web server, Bluehost, GoDaddy, Arvixe, Yahoo, or Google. The online streaming platform 100 may include cloud servers (e.g., “Amazon EC2 Servers”) 110, that may be situated in multiple locations, locally or globally. In one non-limiting embodiment, the cloud servers 110 may utilize the Ubuntu operating system, which allows a developer to enter commands to modify files using approaches that would be difficult, if not impossible, if a GUI was used instead.

A database management system 112 may be installed on one or more of the cloud servers 110. The database management system 112 may be a relational database management system (RDBMS) such as, for example, a Structured Query Language (SQL) server. The database management system 112 may be accessed through command line inputs by a developer, and hold specific information pertaining to the online streaming platform 100. Specifically, the database management system 112 may store information pertaining to users who have subscribed to the online streaming platform 100. For example, the database management system 112 may store information such as, but not limited to, the subscriber username and associated password, the subscriber email address, the e-books that the subscriber has selected for access, and subscriber payment status. The database management system 112 may also store account data associated with the e-book publishers.

The online streaming platform 100 may include storage servers (“Amazon S3 servers”) 120 in communication with one or more of the cloud servers 110 through an encrypted connection 122. Specifically, in one approach a Secure Shell (SSH) link may be used to provide secure communication between the storage servers 120 and the cloud servers 110. Those of ordinary skill in the art will appreciate that in one approach PuTTY, which is open-source terminal emulator, serial console and network file transfer application, creates a command line based interface that may be used by a developer to gain access to the cloud servers 110. Files and codes saved on the cloud servers 110 may be viewed, relocated, deleted, and changed, along with permission and ownership of selected files. Alternatively, in another approach WinSCP (Windows Secure Copy) may be used to provide secure communication between the storage servers 120 and the cloud servers 110 based a graphical user interface. Further, files and code saved on the cloud servers 110 may be viewed, relocated, deleted, and changed more easily than with PuTTY, as long as the developer has permission to make these changes. However, permission and ownership of some files saved on the cloud servers 110 may not be changed using this interface.

The storage servers 120 may be used as an e-textbook library to store the electronic data associated with all the e-books that are available for access through the online streaming platform 100. In one embodiment, the online streaming platform 100 may be viewed upon a GUI 130 of a subscriber's device 102. The device 102 may be, but is not limited to, a smartphone, laptop computer, e-reader, or tablet. The e-books stored within the e-textbook library may be previewed upon the GUI 130 of a subscriber's device 102.

Those of ordinary skill in the art will appreciate that hypertext markup language (HTML) and cascading style sheet (CSS) may be used to create the appearance of the preview upon the GUI 130 of the subscriber's client device 102. In one embodiment, all the e-books stored within the e-textbook library may be viewed in rows, where a user may mouse or hover over a particular e-book in order to preview the contents of a book, such as the book cover, title, author, and ISBN. Those of ordinary skill in the art will appreciate that structured query language (SQL), and/or hypertext preprocessor (PHP) may be used to generate the preview. A user may scroll left and right, and may be able to select buttons such as “more” or “all” to view various books. In one embodiment, the e-books may be arranged by subject matter (e.g., chemistry, physics, etc.), however it is to be appreciated that the e-books may be arranged by other features as well, e.g., title, author, or ISBN. Those of ordinary skill in the art will appreciate that JavaScript may be used to enable a subscriber to scroll through the preview and hover over particular books to obtain a preview. JavaScript may also be used to allow a subscriber to add one or more of the e-books from the e-book library to the subscriber's list of selected materials, which may be saved on a desk feature, which is explained in greater detail below. The user may be able to access the e-books saved on the desk feature.

The desk feature may be a webpage that displays a list of the e-books that the subscriber has selected within the e-textbook library. It is to be appreciated that the subscriber is allowed access a fixed number of e-books within the e-textbook library based on the fees paid. The number of e-books that a subscriber may access and place on the desk feature depend on the specific fee paid by a subscriber, where a higher fee enables a user to access and list more e-books on the desk feature. The subscriber may also modify, change, or swap various e-books that are listed on the desk feature. In one embodiment, the desk feature may track metadata associated with each e-book in order to determine information such as how long the e-book was accessed by the subscriber for reading. Those of ordinary skill in the art will appreciate that Java may be used to track the metadata associated with the e-book.

The online streaming platform 100 allows access to multiple e-books stored within the e-textbook library. However, the e-books remain stored on the storage servers 120, and are not downloadable or otherwise able to be saved to memory of the client devices 102. Further, as subsequently disclosed, the online streaming platform 100 also includes a copyright protection feature that prevents the subscriber from printing, taking screen shots, copying and pasting text, or taking photographs of the GUI 130 using a camera. This is because the subscriber is merely being granted access to an e-book at a lower price than actually purchasing the e-book outright. The fees for accessing the e-books may be paid on periodic basis to maintain access to the e-textbook library. Payment of the fees may be made in the form of an online transaction, where a subscriber's credit card or payment information may be sent over the encrypted connection 122 of the online streaming platform 100. Once payment information is accepted, access to the e-textbook library is granted. Functions, e.g., highlighting, taking notes and bookmarking are all stored on the server with a user's account. The user might be able to view some resources such as saved notes without a paid account, but would be limited to viewing a previously saved note. None of these functions are saved on the user's local device.

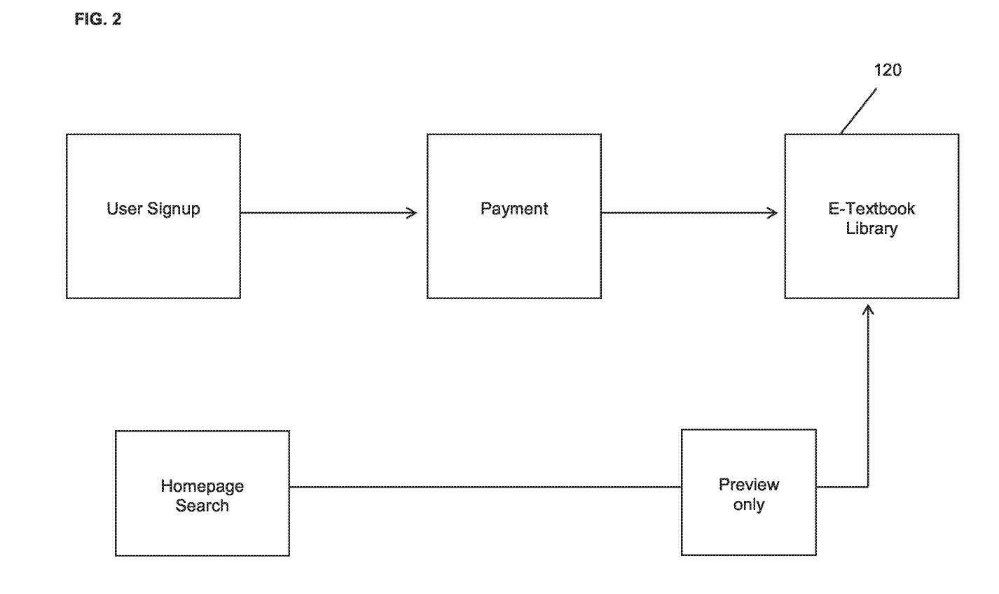

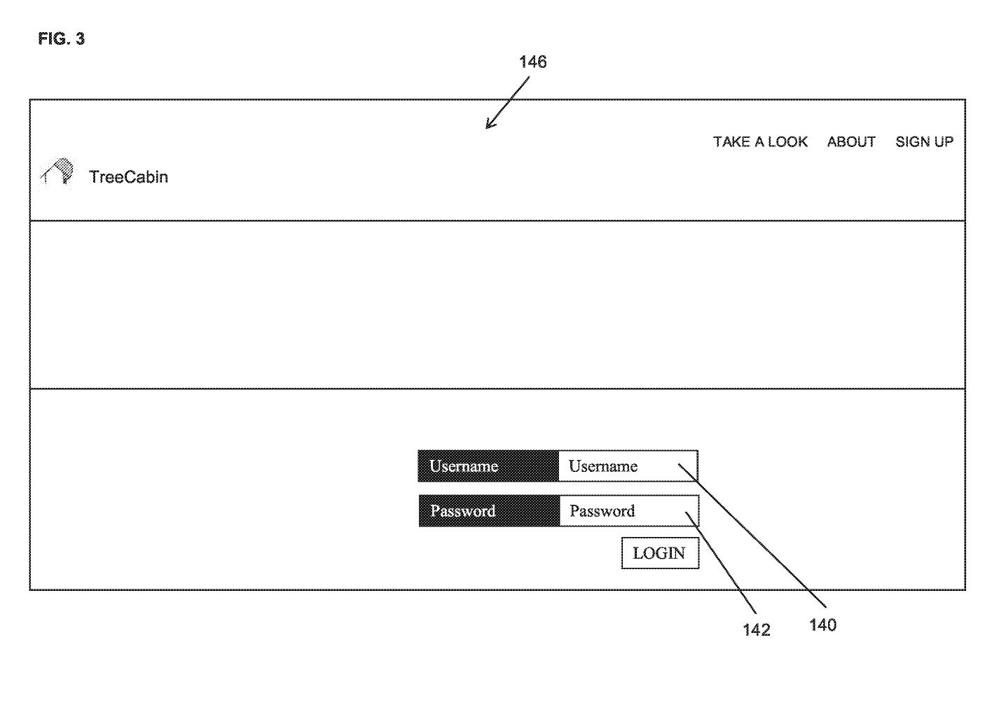

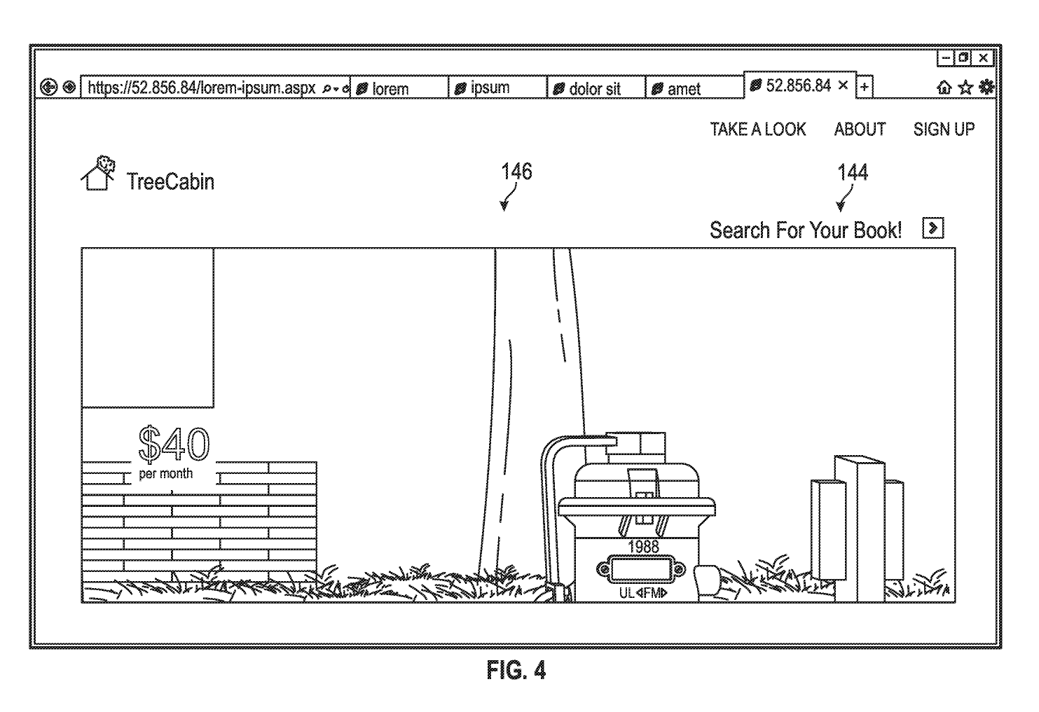

FIG. 2 shows a flow diagram illustrating two ways a subscriber may gain access to the e-textbook library, which is stored on the storage server 120. For example, a user may create a username 140 as well as a password 142, shown in FIG. 3, and then submit payment to gain access to the e-textbook library. However, sometimes an individual may not want to actually subscribe to the online streaming platform 100 unless he or she knows which e-books are available for viewing. Thus, in an alternative approach, the user may click on a search link 144, shown in FIG. 4, that allows preview only access to the e-textbook library. The preview only access to the e-textbook library only allows for an individual to preview books using his or her client device 102. The user is unable to view the actual text of the e-book.

FIG. 3 is an exemplary webpage that illustrates a sign-in page that a subscriber may use to log into his or her account. As seen in FIG. 2, a subscriber' username 140 and password 142 may be required to gain access to a specific account. FIG. 4 is an exemplary webpage that illustrates a home screen 146 generated by the online streaming platform 100.

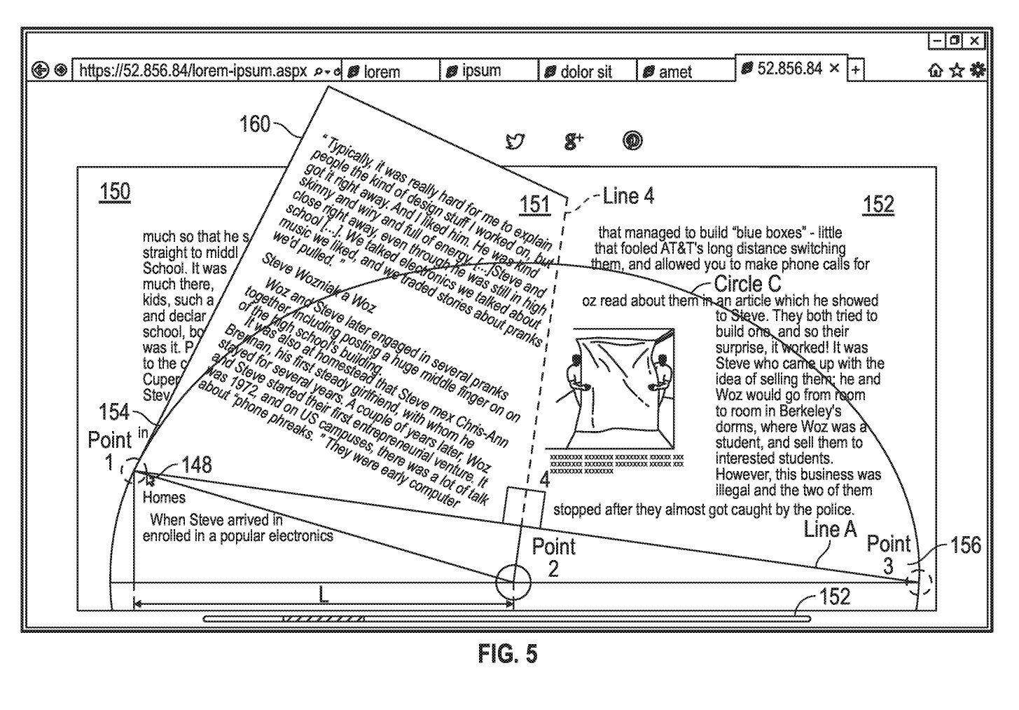

FIG. 5 is a diagram of three exemplary pages 150, 151, 152 of an e-textbook 152, where page 151 is in the process of being turned by a user. The pages 150, 151, 152 may be part of one of the e-textbooks stored within the e-textbook library of the storage server 120 (FIG. 1). In the embodiment shown in FIG. 4, the pages 150, 151, 152 may be provided with an animated two-page flip feature that mimics both the look and sound of turning pages of a traditional book. The e-textbooks stored within the e-textbook library of the storage server 120 may be in an original file format such as, for example, a portable document format (PDF) or a joint photographic experts group (JPEG) format. The storage server 120 may then convert the e-textbook from the original file format to a format compatible with the two-page flip feature such as, e.g., an HTML file. The subscriber may be able to interact with the pages 150, 151, 152 of the e-textbook using the two-page flip feature.

In FIG. 5, point 1 represents where a user may place a mouse 148 or other indicator. The mouse is located at a corner 154 of the page 150. Point 2 represents a midpoint between point 1 and point 3, before the page 151 has been turned, and may serve as an anchor point for rotation as the page 151 is turned. Point 3 represents a corner 156 of the page 152. It is to be appreciated that a user may turn the page 151 left by dragging the mouse 148 towards the page 150, which is located on a left side of the textbook 152. A user may also turn page 151 by instead clicking the mouse 148 along an edge 160 of the page 151. Those of ordinary skill in the art will also appreciate that other approaches may be used to turn the page 151. For example, a user may also turn the page 151 using the left and right arrows keys of a keyboard. As a user turns the page 151, the text to the left or right of line 4 is hidden as the animation sequence of the two-page flip feature is being performed. Thus, page 150 shall be cropped.

A line 4 is shown in phantom line, and is substantially perpendicular to a line A, which connects points 3 and 4 together. A circle C is drawn, where a midpoint of the circle C is located at point 2, and a circumference of the circle C intersects points 1 and 3. A radius of the circle C is equal to a length L of one of the pages 150, 151, 152. The pages 150, 151, 152 may rotate as they are being turned, where rotation begins at: (isUp)*90+(offset), and ends at: −(isUp)*90+(offset). The offset is determined by the specific corner of one of the pages 150, 151, 152, where the offset is equal to about 180° if point 3 is located along one of the upper corners of the page 151, and is equal to about 0° if the point 3 is located along one of the bottom corners of the page 151. The term (isUp) is equal to 1 if point 3 is located along one of the upper corners of the page 151, and is equal to −1 if the point 3 is located along one of the bottom corners of the page 141. The circle C indicates the maximum radius that point 1 may move or travel between the pages 151, 152, and 153. It is to be appreciated that only the text and images located within the circle C will be animated by the two-page flip feature and visible as a user turns the pages 151, 152, and 153.

As seen in FIG. 5, the pages 150, 151, 152 of the e-textbook 152 may contain text as well as illustrations, and include an appearance that is the same as a traditional textbook. The e-textbook 152 may also contain a table of contents (not shown). The user may click on various headings listed in the table of contents to directly access the specific pages of the e-textbook.

Referring to both FIGS. 1 and 5, the online streaming platform 100 may also save links in the storage servers 120 (FIG. 1), to enable the subscriber to mark or place indicators at specific pages of an e-textbook, referred to as a bookmark. The links are unique to a specific subscriber's account and for a specific e-textbook. For example, if the subscriber places a bookmark at page 152, then the link will save a bookmark at page 152. The user may have access to a column (not illustrated in FIG. 5), which may be located to the left side of the GUI 130 of the client device 102. The column is created once the user creates at least one bookmark. Specifically, the link will be displayed under a topic called “Bookmarks”, which is listed within the column. Those of ordinary skill in the art will appreciate that the link may be created based on JavaScript. JaveScript may start an event, where the event may save a page number, placement of the page, the name of the book, and the ISBN number of the book as variables. These variables may be saved on the storage servers 120 (FIG. 1) using PHP. The link may include an option that enables the user to also change the color, name or page placement of the link as well.

In addition to bookmarks, the online streaming platform 100 may also highlight the text or illustrations within any of the e-textbooks the subscriber has selected for access as part of his or her subscription. The highlight may be made in various colors, e.g. yellow, red, or blue. Specifically, a highlight button (not shown) may be visible upon the GUI 130 of the client device 102. The subscriber may select the highlight button and may then select text or an illustration that requires highlighting. An unhighlight button (not shown) may also be visible upon the GUI 130 of the client device 102. The subscriber may select the unhighlight button and may then select text or an illustration that requires highlighting. The highlight and unhighlight buttons are positioned along the GUI 130 of the client device 102 such that the user is able to locate and easily select these buttons.

In one embodiment, a CSS code may be provided for changing the color of a text selector. The text selector is the box that is generated as a user drags the mouse over the text or illustrations on the pages 150, 151, 152 of the e-textbook 152. A JavaScript function instructs the highlight and unhighlight buttons (not illustrated) what functions need to be performed with the selected text. In one embodiment, the text selector includes a default color of blue, where the CSS code may be used to change the color of the text selector from blue to a lighter shade of blue. The CSS may be used to ensure that the color of the text selector remains light blue, regardless of the font of the selected text (i.e., regardless of whether the font is italicized, bolded, etc.).

A function may be created that instructs JavaScript to identify the selected text, and to also put mark tags around the selected text. The mark tags will generate a yellow box around the selected text when the highlight button is selected, which gives the appearance of highlighted text. It is to be appreciated that yellow is merely the default highlight color, and that CSS code may be used to modify the color of the highlight. Furthermore, the CSS code may also be used to create a second set of mark tags, which include generates a white box around the selected text when the highlight button is selected and gives the appearance of unselected text. The second mark tags may be used when the unhighlight button is selected. When a user selects the unhighlight button, the second mark tags activate and place the white box along the highlighted text. Another function may also be created which instructs JavaScript to identify the selected text, and to put the second mark tags around the selected text. However, this action may only be used if the selected text is currently highlighted.

In addition to bookmarks and highlighting, the online streaming platform 100 may further include note taking features. In one embodiment, a user may be able to place text boxes anywhere upon a page of the e-textbook. The text box may include any type of available character or icon. The text boxes may be organized based on any parameter such as, e.g., date, or by alphabet. The purpose of the note taking features are to enable a user to write down any piece of information they may believe is important and quickly access the information as well. Specifically, a text box or note taking button (not shown) may be visible upon the GUI 130 of the client device 102. The subscriber may select the note taking button. A document may then open, which allows for the user to type notes, which may include text or other characters. The notes may then be saved in a folder located on the storage servers 120 (FIG. 1). It is to be appreciated that the folders may be organized so that only one set of notes unique to a specific e-textbook may be available. Thus, a user does not need to sort through various notes from other e-textbooks that they may not need. However, all of the notes the user has taken shall be accessible if no e-textbook is currently open. Notes may also be deleted by selecting the note and then selecting a delete function (not shown).

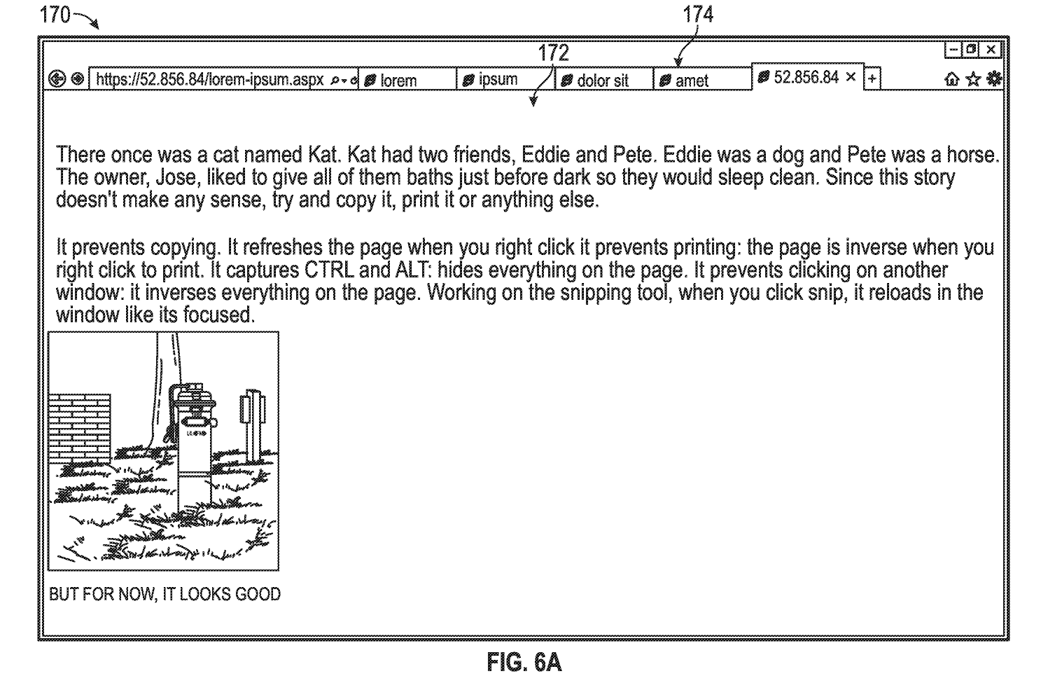

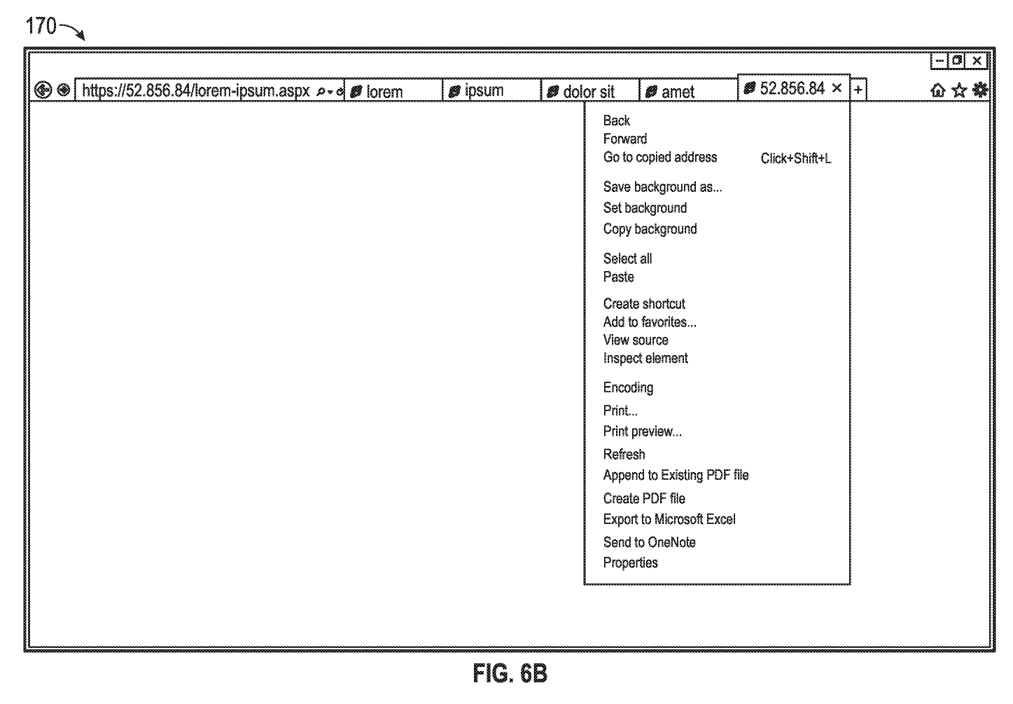

FIGS. 6A-6B are exemplary screens 170 that demonstrate a copyright protection feature of the online streaming platform 100 (FIG. 1), which prevents the subscriber from reproducing text. Some examples of reproducing text include, e.g., printing, taking a screen shot, or copying and pasting the text from the e-textbook to another application on his or her client device 102 (FIG. 1). If the subscriber selects or clicks on an area of the screen 170 located outside a window's 172 margins 174 using the mouse (not shown in FIGS. 6A-6B), then the text shown within the window 172 may be inverted along its x-axis to prevent the subscriber from copying the text. The inverted text is an example of the output produced when the browser is minimized or out of focus. This prevents other applications from taking a screenshot of the adjacent browser. If the subscriber attempts to right-click using the mouse to copy a portion of the text or to print one or more pages of the e-textbook, the window 172 automatically performs a refresh operation, and the window 170 goes blank as seen in FIG. 6B. Once the window 172 goes blank, the user is unable to select text to copy and paste to another application on his or her client device 102. That is, the online streaming platform 100 monitors an area of the screen 170 of the client device 102 located outside of the window's 172 margins 174. The window 172 may be considered a separate viewing area on the screen 170 of the client device 120. As seen in FIG. 6A, the window 172 contains a plurality of characters oriented along an x-axis (e.g., the horizontal text that reads “[t]here once was a cat named Kat”). The online streaming platform 100 determines if the subscriber has selected text on the area of the screen 170 located outside of the window's 172 margins 174 using a selector such as a mouse. In response to determining that the subscriber has selected text outside of the window's 172 margin 174, the online streaming platform inverts the characters oriented along the x-axis (FIG. 6A).

Those of ordinary skill in the art will appreciate that JavaScript may be used to generate the copyright protection features. The C++ code will be run from server side and placed as an add-on if needed. This will not be installed on the user's device but rather the user will grant it permission to monitor the PRTSC key prior to having access to the books.

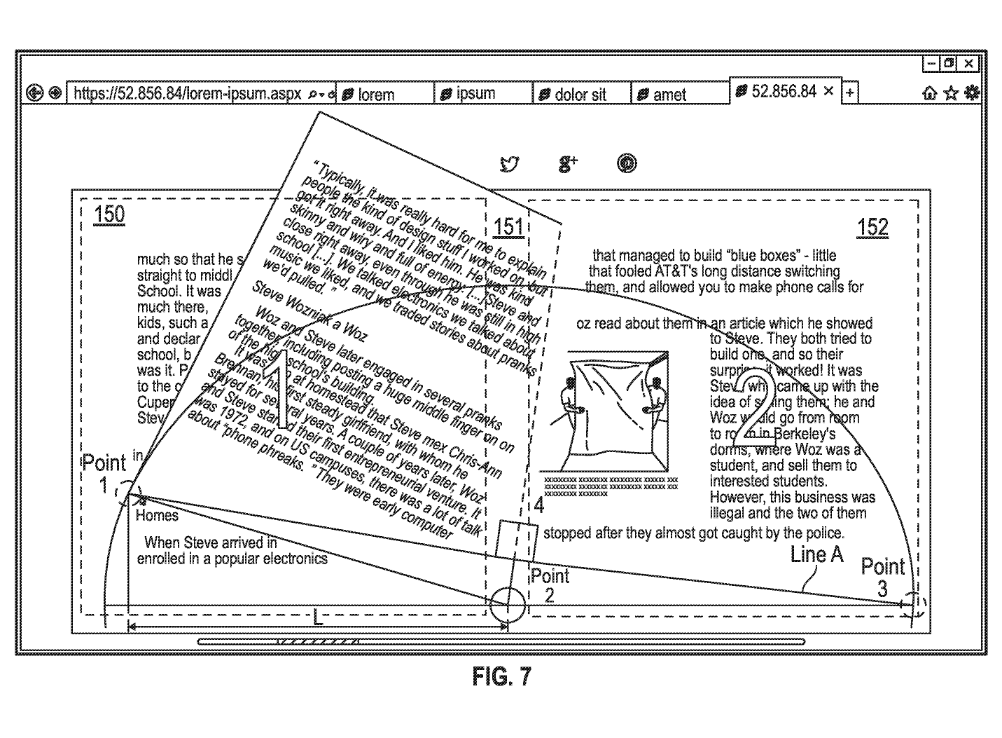

The online streaming platform 100 (FIG. 1) may also prevent a subscriber from taking photographs of the GUI 130 of the client device 102 (FIG. 1) using another electronic device such as, e.g., the camera of a smartphone or a digital camera. FIG. 7 is an exemplary view of the pages 150, 151, 152 of the e-textbook 152, where two blocks, block 1 and block 2 are superimposed. Referring to FIGS. 1 and 7, the online streaming platform 100 may send encrypted data to the client device 102 based on elevated screen refresh rates. It is to be appreciated that a conventional computer screen, either an LED or LCD screen, generally refreshes at a rate of about 60 Hz. If the GUI 130 of the client device 102 is refreshed at a higher rate than 60 Hz, the refresh is undetectable by the human eye, and if a user attempts to photograph the GUI 130, a blur will appear. As seen in FIG. 7, block 1 may refresh at a first rate, and block 2 may refresh at a second rate that is greater than the first rate. Black 2 may pass over block 1, in essence block 1 will intersect with block 2 and cross paths as one is traveling after than the other. In one embodiment, the first refresh rate may be about 24 Hz and the second refresh rate may be between about 60 to 74 Hz, but may depend on the specific size of the monitor of the client device 102. The sizes of the block 1 and 2 may depend of the pixel width of the monitor of the client device 102, since smaller devices such as smartphones have a smaller pixel width. Block 1 and block 2 may be comprised of a mixture of black, white, and/or gray pixels or, alternatively, may be colored.

In one approach, the e-textbook may be saved as an ePub file. Those of ordinary skill in the art will readily appreciate that the term ePub stands for an electronic publication. Turning back to FIG. 1, in one approach a subscriber may wish to view or read an e-textbook from the online e-textbook library 104 that is saved in an ePub format upon his or her client device 102. Accordingly, the online streaming platform 100 may need to convert the ePub file stored in the online e-textbook library 104 into a format that is compatible with a two-page flip feature such as, for example, an HTML file. However, the online streaming platform 100 may not need to convert the entire ePub document at once into a compatible format, since some types of ePub files may be relative large in size (e.g., 10 MB or more). Instead, the online streaming platform 100 may render images of pages 150, 151, 152 within the textbook 152 (seen in FIG. 5) dynamically. That is, the online streaming platform 100 may render the pages 150, 151, 152 in real-time. This allows for the subscriber to view content stored in an ePub file, or any type of text file, using the streaming platform 100.

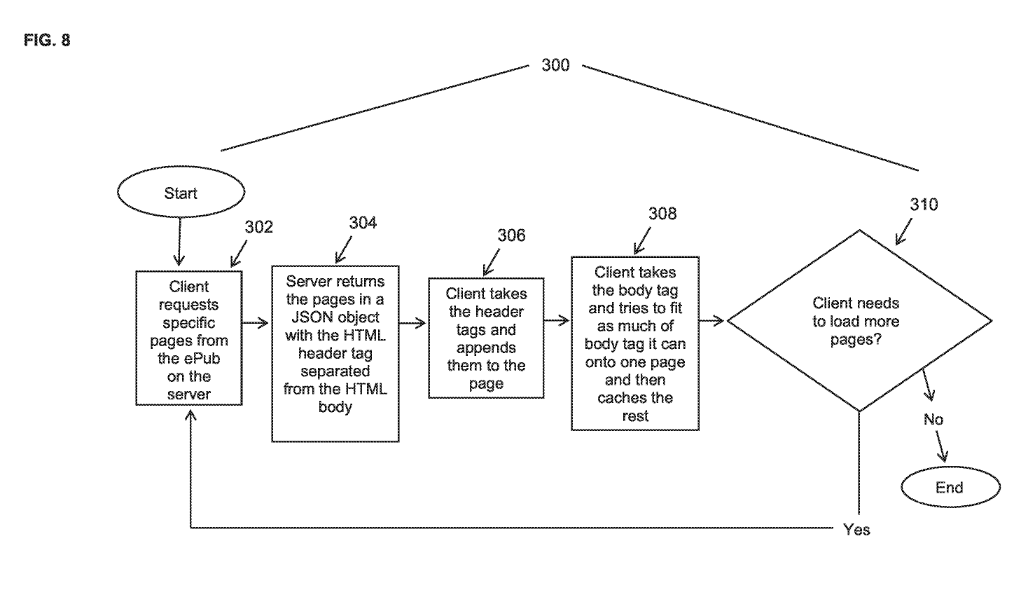

FIG. 8 is a process flow diagram illustrating an exemplary method 300 for dynamically rendering pages based on an ePub file. Referring to both FIGS. 1 and 8, method 300 may begin at block 302, where the client device 102 requests specific pages relating to a particular ePub file that is stored on the server (i.e., the textbook library 104). Method 300 may then proceed to block 204. In decision 304, the server returns the requested pages in a JavaScript Object Notation (JSON) object with an HTML header tag that is separated from the HTML body. Method 300 may then proceed to block 306. In block 306, the client device 102 make take the header tags and appends them into pages of an e-textbook. Method 300 may then proceed to block 308. In block 308, the client 102 attempts to fit as much content of the HTML body tag into a single page that was created in block 306. The client 102 may then cache the remaining content of the HTML body tag. Method 300 may then proceed to decision block 310. In block 310, if the client 102 needs to load more pages, then method 300 may return to block 302. However, if the client 102 does not need to load any more pages, then method 300 may terminate.

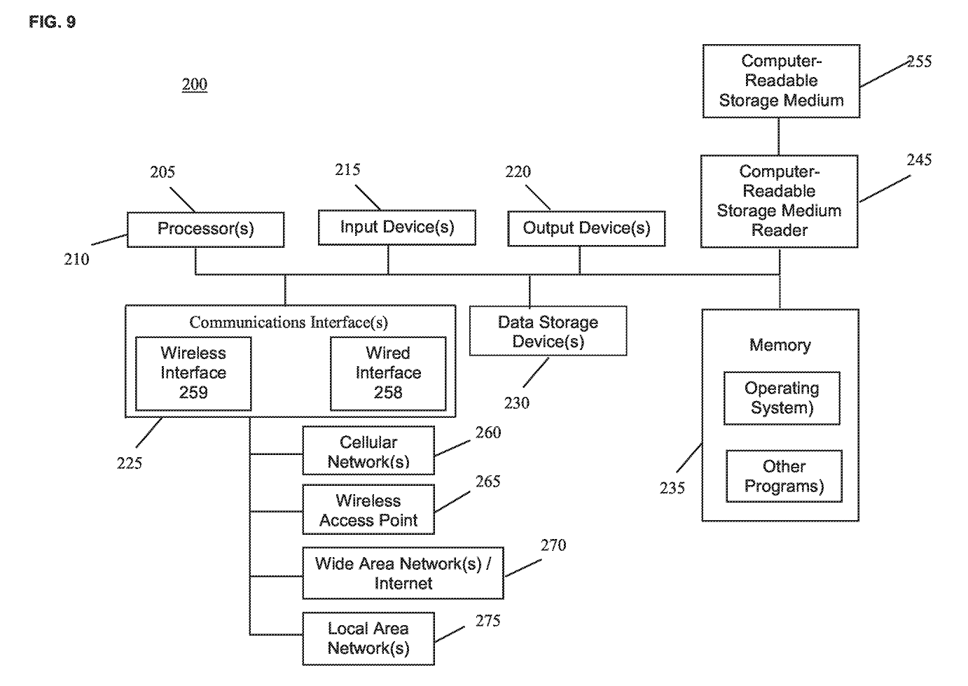

FIG. 9 shows a block diagram of a computer system 200 illustrating one possible hardware configuration to support the disclosed systems and methods. It will be appreciated that the invention may be implemented using alternative hardware configurations. Computer device 200 may be in the form of a desktop computer, a laptop computer, a tablet computer, a server, a virtual server operating on one or more computer devices, a cellular device, a mobile phone, a smart phone, a mobile computer, a mobile device, a handheld device, a media player, a personal digital assistant, etc. including combinations of items.

The computer system 200 includes a processor 205, such as any commercially available central processing units offered by Intel, A M D, and Motorola, coupled to a communications channel 210. Communications channel 210 may include any of several types of bus structure such as a system bus, a memory bus or memory controller, a peripheral bus, and a local bus using any of a variety of commercially available bus architectures designed to effect communication between various components of the computer system. Dual microprocessors and other multi-processor architectures may also be employed as the processor 205. The computer system 200 further includes an input device 215 such as a keyboard or mouse, an output device 220 such as a LCD, plasma, or LED display, a communications interface 225, a data storage device 230 such as a magnetic or optical (read-only or rewritable) disk, or solid state drive, and memory 235 such as Random Access Memory (RAM), each coupled to the communications channel 210. One skilled in the art recognizes that, although the data storage device 230 and memory 235 are shown as different units, the data storage device 230 and memory 235 may be parts of the same unit, distributed units, virtual memory, etc., and that the term “memory” as used herein is intended to cover all data storage media, including ROM and RAM or any memory known by one skilled in the art, whether permanent or temporary. The communications interface 225 may be coupled by wired 258 or wireless 259 interfaces to a cellular telephone network 260, a wireless access point 265, a wide area public network, for example, the Internet 270, and or a local area private network 275, for example an Ethernet LAN. One skilled in the art will readily recognize that data may be transmitted in both wired 258 and wireless 259 interfaces in any number of available protocols. One skilled in the art will recognize that for the purposes of this disclosure, fiber optic transmission of data is a form of wired data transmission, and that wireless data transmission can occur in a wide variety of suitable forms such as acoustic, RF, infrared, and other wireless transmission media.

A basic input/output system (BIOS), containing the basic routines used to transfer information between elements within the computer system 200, such as during start-up, is stored in the data storage device 230 or in memory 235. The data storage device 230 or the memory 235 may also store an operating system 240 such as Microsoft Windows, Linux, Unix, MAC OS, etc. The operating system 240 in the computer system 200 can be any commercially available operating system and/or web client system, and/or open source operating system, covering the spectrum of consumer electronics devices including but not limited to cameras, video recorders, personal media players, televisions, remote controls, etc., as well as all web client systems including commercial and open source platforms providing thin-client access to the cloud. The data storage device 230 or the memory 235 may store a number of other items, including one or more application programs, other program modules, and program data. Embodiments of the invention may also be implemented on platforms and operating systems other than those mentioned. Embodiments of the invention may be written using Java, C++, C, C#, Perl, PHP or any commonly available programing languages.

Computer system 200 may intercommunicate with a wide variety of other devices over networks by way of communications interface 225. Computer system 200 may also include additional components such as additional network connections, additional wireless network connections, additional memory, additional processors, and additional communications interfaces. Programs and data may be received by and stored in computer system 200 in alternative ways. For example, a computer readable storage medium reader 245 for removable media, such as a magnetic disk drive dock, a flash media reader, an optical disk drive, or an interface bus device such as USB, Firewire, or eSATA-linked external drive (for, for example, a flash or so-called ‘thumb drive’), may be coupled to the communications channel 210 for reading a computer readable storage medium 255, such as a magnetic disk drive, a flash card, an optical disk, a flash drive, a portable storage device, or other devices. The communications interface 225 coupled to communications channel 210 can access data stored on the Internet 270. Thus, the computer system 200 may receive programs or data by the computer readable storage medium 250 or by the communications interface 225 for storage on the data storage device 230 of the system itself.

The embodiments shown and described in the specification are only specific embodiments of inventors who are skilled in the art and are not limiting in any way. Therefore, various changes, modifications, or alterations to those embodiments may be made without departing from the spirit of the invention in the scope of the following claims. The references cited are expressly incorporated by reference herein in their entirety.

What is claimed is:

1. An online streaming platform comprising
a plurality of cloud servers storing subscriber information; and
a plurality of storage servers in communication with the plurality of cloud servers, wherein at least one of the storage servers stores a e-textbook library containing the contents of a plurality of e-books, wherein the online streaming platform allows for subscribers to access a fixed number of e-books within the e-textbook library for a fee that is paid on a periodic basis.

2. The online streaming platform of claim 1 where a client device is in communication with one of the plurality of storage servers, and wherein the plurality of e-books are not saved or downloadable to the client device.

3. The online streaming platform of claim 2 where at least two pages of a selected one of the plurality of e-books are shown upon a display of the client device, and wherein the at least two pages are stored within the e-textbook library of one of the storage servers.

4. The online streaming platform of claim 3 where the at least two pages of the selected one of the plurality of e-books are turned based on a two-page flip feature.

5. The online streaming platform of claim 1 where the online streaming platform is configured to highlight at least one of text and illustrations on a specific page of an e-textbook.

6. The online streaming platform of claim 5 where the online streaming platform is configured to change a color of the highlight on the specific page of the e-textbook, and wherein a default color of the highlight is blue.

7. The online streaming platform of claim 1 where the online streaming platform is configured to place text boxes on a specific page of an e-textbook, and wherein the text boxes include at least one of a character and an icon.

8. The online streaming platform of claim 1 where the online streaming platform saves links in the storage server that represent bookmarks, and wherein the bookmark enables a subscriber to place an indicator at a specific page of an e-textbook.

9. The online streaming platform of claim 1 where the fixed number of e-books is based on the fee that is paid on the periodic basis, and wherein a higher fee enables a subscriber to access more of the plurality of e-books.

10. The online streaming platform of claim 1 where at least one of the plurality of e-books are stored as an electronic publication file.

11. The online streaming platform of claim 10 where the online streaming platform dynamically converts the electronic publication file into a format that is compatible with a two-page flip feature.

12. A system for preventing a subscriber from reproducing text displayed upon a screen of a client device, the system comprising
at least one processor; and
a memory coupled to the one or more processors, the memory storing data comprising program code that, when executed by the one or more processors, causes the system to
monitor an area of the screen of the client device that is located outside of a window's margins, wherein the window is a separate viewing area on the screen of the client device, and wherein the window contains a plurality of characters oriented along an axis;
determine if a subscriber has selected text on the area of the screen located outside of the window's margins using a selector;
in response to determining that the subscriber has selected text outside of the window's margin, inverting the plurality of characters oriented along the axis.

13. The system of claim 12 where the axis is an x-axis that is oriented horizontally.

14. The system of claim 12 where reproducing text includes at least one of printing, taking a screen shot, and copying and pasting the characters.

15. A system for preventing a subscriber from reproducing text displayed upon a screen of a client device, the system comprising
at least one processor; and
a memory coupled to the one or more processors, the memory storing data comprising program code that, when executed by the one or more processors, causes the system to
monitor an area of the screen of the client device that is located outside of a window's margins, wherein the window is a separate viewing area on the screen of the client device, and wherein the window contains a plurality of characters;
determine if a subscriber has selected text on the area of the screen located outside of the window's margins using a selector;
in response to determining that the subscriber has selected text outside of the window's margin, removing the characters from the window so that the window appears blank.

16. The system of claim 15 where reproducing text includes at least one of printing, taking a screen shot, and copying and pasting a plurality of characters displayed upon the window.

17. A system for preventing a subscriber from photographing a display of a client device by another electronic device, the system comprising
at least one processor; and
a memory coupled to the one or more processors, the memory storing data comprising program code that, when executed by the one or more processors, causes the system to:
send data to the client device to refresh the display at a predetermined rate, wherein the predetermined rate is higher than about 60 Hz.

18. The system of claim 17 where the system is configured to display at least two pages of an e-book upon the display of the client device, and wherein the system creates a first block and a second block that are superimposed upon the at least two pages.

19. The system of claim 18 where the system is configured to send data at a first refresh rate and a second refresh rate, and where the first block is refreshed at the first rate and the second block is refreshed at a second rate.

20. The system of claim 19 where the second refresh rate is greater than the first refresh rate.

21. The system of claim 18 where sizes of the first block and the second block are based on a pixel width of the display of the client device.
